(19) United States
(12) Patent Application Publication
(10) Pub. No.: US 2007/0282885 A1
(43) Pub. Date: Dec. 6, 2007

(54) Method and System For Application Interaction

(76) Inventors: Brent J. Baude, Rochester, MN (US); Jaroslaw Miszczyk, Rochester, MN (US); Gottfried Schimunek, Rochester, MN (US); Kathryn Sintal, Waterford, PA (US)

Correspondence Address: LIEBERMAN & BRANDSDORFER, LLC, 802 STILL CREEK LANE, GAITHERSBURG, MD, 20878, US

(21) Appl. No.: 11/421,276

(22) Filed: May 31, 2006

(51) Int. Cl. G06F 17/00

(52) U.S. Cl. 707/102

(57) ABSTRACT

A method and system for modifying a single characteristic of a set of related user interface artifacts. An XPath expression is used to select a set of nodes to be modified. A mechanism is then used to modify each of the nodes in the selected set in a single communication.

### BACKGROUND OF THE INVENTION

1. Technical Field

This invention relates to manipulation of user interface artifacts. More specifically, a method and system are provided for efficiently manipulating a set of user interface artifacts as a single unit.

2. Description Of The Prior Art

Extensible Markup Language, XML, is a specification developed by the World Wide Web Consortium,W3C. XML is a standard markup language that utilizes clear text character sets, such as ASCII or Unicode, to store both content and structure of a document. The XML language encodes documents into a predefined organizational structure. Therefore, there is no preprocessing of the document required following amendment to the document content. Revisions to the document content and structure are reflected immediately. Context internal to a document is reflected by the document's structure, while context of references to subsets of other documents have no contextual reference, merely a target value. Accordingly, electronic documents encoded in XML format are dynamically updateable and do not require reindexing of contextual information subsequent to modification of the document content.

A user interface artifact is an object that is part of a user interface, such as a window, panel, text box, label, or button. User interface artifacts, their attributes, and the relationship among different artifacts are commonly specified in the form of an XML document. As such, a user interface presentation system dynamically renders a user interface based on the specification described in an XML document. However, there are a large quantity of proprietary user interface systems in the marketplace. Most of these system are incompatible, with each system requiring applications use a proprietary application program interface to communicate with user interface artifacts. This incompatibility aspect both increases the development costs and reduces the application portability for those who need to deploy across heterogeneous environments or platforms.

FIG. 1 is a prior art flow chart (10) illustrating a typical method for manipulating a user interface artifact based on the proprietary interface systems in the marketplace. As noted above, user interface artifacts may be described in an XML document, with each artifact in the document being represented as a node. An XML formatted document pertaining to the user interface artifacts is retrieved (12) and parsed (14) to identify the elements of the document that make up the nodes of the hierarchical tree structure. The process of parsing the XML document is to place the attributes of the user interface into a tree structure with a root node, child nodes, sibling nodes, etc. Based upon the parsed information at step (14), an internal representation of the XML hierarchy is built (16). In order to manipulate any of the artifacts represented in the XML hierarchy, a proprietary application program interface (API) must be used. At step (18), an API is used to select one of the artifacts represented in the XML hierarchy and to modify an attribute of the selected artifact (20). Following the modification at step (20), a test is conducted to determine if another artifact should be modified (22). A positive response to the test at step (22) will return to step (18). Similarly, a negative response to the test at step (22) will end the interface modification process (24). Accordingly, the process outlined in FIG. 1 supports modification of an attribute of a user interface artifact on a limited basis.

As shown in FIG. 1, the prior art modification of a user interface attribute is conducted on a singular basis with use of a proprietary application program interface. As shown, existing APIs do not provide an easy way to manipulate sets of user interface artifacts that are unrelated in terms of their position in the user interface hierarchy. Accordingly, there is a need for a solution that support modification of related user interface artifacts across heterogeneous environments or platforms.

### SUMMARY OF THE INVENTION

This invention comprises a method and system for communicating with sets of user interface artifacts.

In one aspect of the invention, a method is provided for manipulating nodes of an XML formatted document. Nodes of the XML document are described in a hierarchy. This described hierarchy is navigated to select at least one set of nodes to be processed with an XPath expression. Thereafter, the XPath expression is evaluated to manipulate the selected set of nodes. These nodes are characteristics of user interface artifacts.

In another aspect of the invention, a computer system is provided with an XML formatted document that has multiple nodes described in a hierarchy. A manager is provided in the system to navigate the hierarchy and to select a set of nodes to be processed with an XPath formatted expression. The manager evaluates the XPath expression and manipulates said selected set of nodes. These nodes are characteristics of user interface artifacts.

In yet another aspect of the invention, an article is provided with a computer readable medium. Means in the medium are provided for describing nodes of an XML document in a hierarchy. Means in the medium are also provided for navigating the hierarchy and selecting at least one set of nodes for processing with an XPath expression. In response to the node selection, means in the medium are provided for evaluating the XPath expression to manipulate the selected set of nodes. These nodes are characteristics of user interface artifacts.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a flow chart of a prior art method for selecting and manipulating nodes of an XML formatted document associated with a user interface.

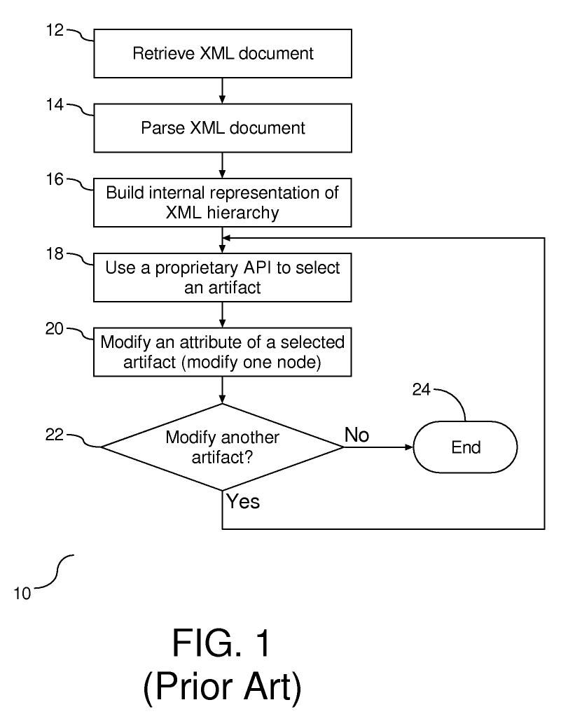

FIG. 2 is a flow chart of a method for selecting and manipulating nodes of an XML formatted document associated with a user interface according to the preferred embodiment of this invention, and is suggested for printing on the first page of the issued patent.

FIG. 3 is a block diagram of a parsed XML document.

FIG. 4 is a block diagram of a computing device.

### DESCRIPTION OF THE PREFERRED EMBODIMENT

### Overview

User interface artifacts, their attributes, and the relationship among the different artifacts are specified in an XML document. Each attribute of a user interface artifact is represented as a node in the XML document. An XPath expression is used to locate a set of nodes, i.e. user artifacts, in the XML document, and to access a set of user interface artifacts that share a common characteristic and/or property. Non-proprietary application program interfaces (APIs) are used to communicate with the XPath selected artifacts and to modify them as a group selection.

### Technical Details

XPath is a language for finding information in an XML document. XPath is used to navigate through elements and attributes in an XML document. XPath uses path expressions to select nodes or node-sets in an XML document. In XPath, there are seven kinds of nodes: element, attribute, text, namespace, processing-instruction, comment, and document (root) nodes. XML documents are based upon a hierarchy and are treated as digital trees with nodes in the tree representing select elements of the document. The root of the tree is called the document node (or root node).

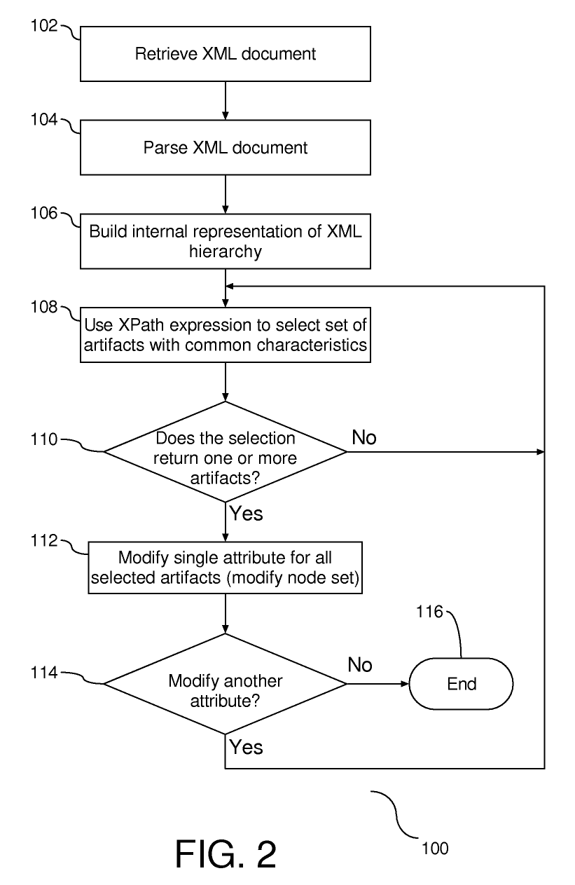

FIG. 2 is a flow chart (100) illustrating a method for modifying user interface artifacts described in an XML document on a dynamic basis. An XML formatted document is used to describe user interface artifacts, the attributes of the artifacts, and the relationship among the artifacts. This XML document is retrieved (102), and parsed (104). As noted above, an XML document is a predefined organizational structure. The XML document is parsed at step (104) to identify the elements of the document that make up the nodes of the hierarchical tree structure. The process of parsing the XML document is to place the attributes of the user interface into a tree structure with a root node, child nodes, sibling nodes, grand-children nodes, etc. Following step (104), the internal representation of the XML hierarchy is built (106). Typically, it is built in the computer'memory device. The internal representation is needed to facilitate navigation through the hierarchy. In one embodiment, the implementation may be in the form of document object model (DOM). Following step (106), an XPath expression is used to select a set of user interface artifacts, i.e. nodes, that have a common characteristic and/or property and are present in the XML document (108). A node set selected by a given location path can produce one or many artifacts. Following the selection, it is determined whether the selection returned one or more user interface artifacts (110). The manipulation of the user interface artifacts requires one or more artifacts be present in the selection process. If the response in step (110) is positive, the returned node set is modified (112). The modification at step (112) encompasses modifying a single attribute present in each of the user interface artifacts represented in the returned node set through a mechanism that indicates the changes to be applied to the selected node set. In one embodiment, the mechanism is an application program interface (API). If the response in step (110) is negative, the process returns to step (108) to satisfy the requirement of selection of a set of user interface artifacts with a common characteristic and/or property. Following step (112), it is determined whether to modify another user interface artifact (114). A positive response in step (114) causes the process to return to step (108) to satisfy the requirement of selection of a set of artifacts with a common characteristic and/or property. However, a negative response in step (114) will result in conclusion of the user interface modification process (116). The process outlined in FIG. 2 demonstrates activity of a single thread. In one embodiment, multiple threads may use the logic shown in FIG. 2 to independently modify separate sets of nodes simultaneously or near-simultaneously. The process demonstrated in FIG. 2 is not limited to user interface artifacts described in an XML document. Rather, the same process may be applied to identify and select nodes represented in any XML document that share a common characteristic. Accordingly, the process outline in FIG. 2 is an illustration of selecting a set of nodes in an XML formatted document that share a common characteristic in the form of a user interface artifact, and using a single communication to modify a single attribute present in the select set of nodes.

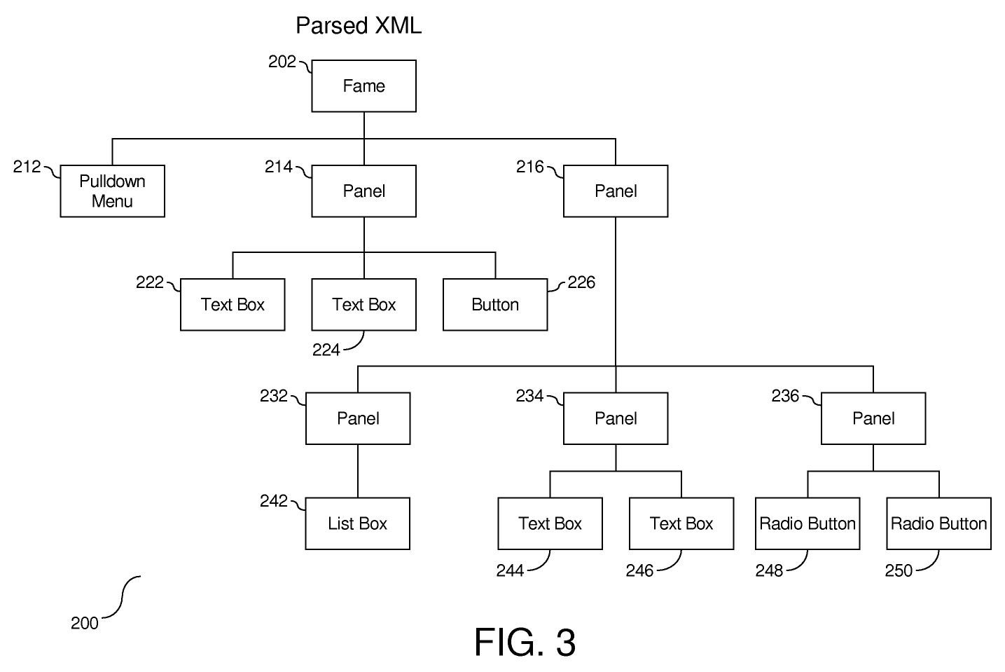

FIG. 3 is a block diagram (200) of an example of a parsed XML document. As shown, the XML document in this example pertains to a user interface presentation system. In the example shown in FIG. 3, there are six categories of artifacts shown in the parsed document. There is a frame (202) that serves as the root element. There are a set of children nodes (212), (214), and (216). In the example of FIG. 3, One of the children nodes (212) represents a pull down menu, and the other two children nodes (214) and (216) each represent panels in the user interface presentation. One of the child nodes (214) has a further generation of nodes (222), (224), and (226) with nodes (222) and (224) representing text boxes, and nodes (226) representing a button. In addition, one of the child nodes (216) has a further generation of nodes (232), (234), and (236) with each of these nodes representing a panel in the user interface presentation. The first of these child nodes (232) has a child node (242) in the form of a listbox in the user interface presentation. The second of these child nodes (234) has two children nodes (244) and (246) in the form of text boxes in the user interface presentation. The third of these children nodes (236) has two children nodes (248) and (250) each in the form of radio buttons in the user interface presentation. An XPath expression is used to select a set of user interface artifacts with a common characteristic and/or property. For example, based on the parsed XML document shown in FIG. 3, such characteristics include a frame, a pull down menu, a panel, a text box, a list box, and a radio button. An XPath expression that selects the frame artifact will return a node set with only one node present, e.g. (202). However, an XPath expression that selects a panel artifact will return a node set with five nodes present, e.g. (214), (216), (232), (234), and (236). As noted above, the XPath expression is used to select one or more nodes in the XML parsed document, and a mechanism, such as an API, is then used to modify a characteristic and/or property of the selected node(s). Examples of user interface APIs include, but are not limited to, retrieving the current value of an attribute, setting the value of an attribute, registering an event handler to be called back when a user interface event occurs, unregistering an event handler, painting the artifacts selected, and erasing the artifacts selected. When an XPath expression calls one of the supported APIs, the user interface presentation system locates all of the nodes in the parsed XML document representing the user interface that satisfy the XPath expression and performs the requested action. For example, an API may be implemented that calls to set the value of a font in the panel in the user interface. The XPath expression selects all user interface artifacts that are identified as panels, and then the API changes the font attribute of all of the panels in the XML parsed document. Following the setting of the value of the font, a second API may be enacted to actually paint the selected artifacts so that the changed font attribute takes effect.

In one embodiment, the invention is implemented in software, which includes but is not limited to firmware, resident software, microcode, etc. The invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

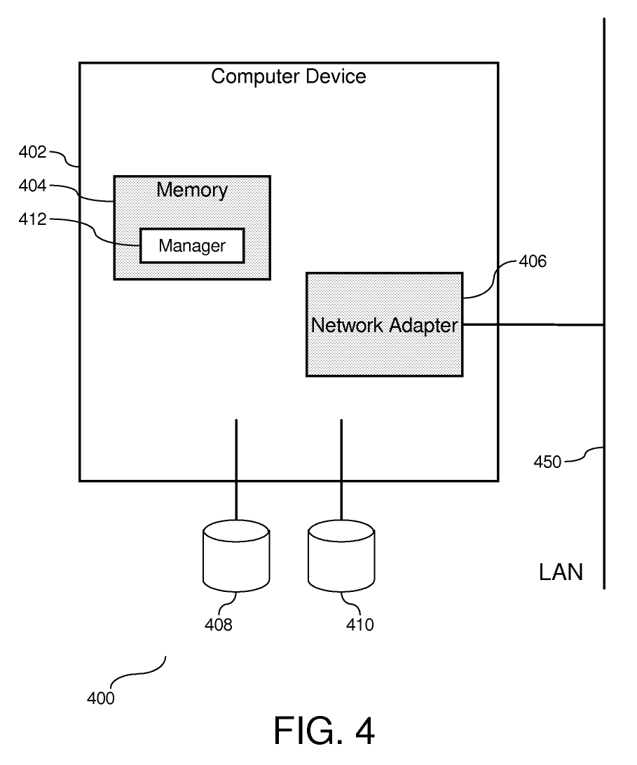

In one embodiment, a selection manager is provided in software or hardware. With respect to the software implementation, the manager may include, but is not limited to, firmware, resident software, microcode, etc. The software implementation can take the form of a computer program product accessible from a computer-useable or computer-readable medium providing program code for use by or in connection with a computer or any instruction execution system. FIG. 4 is a block diagram (400) illustrating placement of the manager in the system hardware. The illustration shows a computing device (402) with memory (404). As shown, the computing device (402) may communicate across a network (450) through a network adapter (406). User interface artifacts are stored in an XML document (not shown) that may reside in local data storage (408) and (410), or remote data storage (not shown) that is accessible through communications across the network (450). A manager (412) is shown residing in memory (404) of the computer device (402). The manager may implement instructions to select a specific XML document describing the user interface artifacts. Following the selection of the XML document, the manager may implement instructions to navigate the hierarchy of the selected document to select a set of artifacts to process. In one embodiment, an XPath expression is used by the manager to select a set of nodes in the XML document that are relevant to the user interface artifacts. The manager evaluates and manipulates the selected set of artifacts.

For the purposes of this description, a computer-useable or computer-readable medium can be any apparatus that can contain, store, communicate, propagate, or transport the program for use by or in connection with the instruction execution system, apparatus, or device.

Network adapters may also be coupled to the system to enable the data processing system to become coupled to other data processing systems or remote printers or storage devices through intervening private or public networks. Modems, wireless and Ethernet adapters are just a few of the currently available types of network adapters.

### Advantages Over the Prior Art

The use of an XPath expression to selected a set of nodes in an XML document, enables modification of the selected set through a single communication. The XPath expression is used to select a set of nodes within the document that share a common characteristic and/or property. The selected set of nodes can be unrelated in the sense of the parent-child relationship. A mechanism that indicates what changes are to be applied to the selected node sent, such as an API, proprietary or non-proprietary, is then used to modify the selected set of nodes in a single communication.

### Alternative Embodiments

It will be appreciated that, although specific embodiments of the invention have been described herein for purposes of illustration, various modifications may be made without departing from the spirit and scope of the invention. In particular, the user interface presentation system may retrieve an XML document containing the data necessary to dynamically render a user interface from media in the form of a hard drive, optical drive, network drive, or message queue. Similarly, the invention should not be limited to an XML document that describes user interface artifacts. Rather, the invention may be applied to any XML document and selection and manipulation of a set of nodes from the XML document that share a common characteristic. Accordingly, the scope of protection of this invention is limited only by the following claims and their equivalents.

We claim:

1. A method for manipulating nodes of an XML formatted document comprising:
describing nodes of said XML document in a hierarchy;
navigating said hierarchy to select at least one set of nodes for processing with an XPath expression; and
evaluating said XPath expression to manipulate said selected set of nodes, wherein said nodes are characteristics of user interface artifacts.

2. The method of claim 1, wherein said selected set of nodes are related by a common property.

3. The method of claim 1, further comprising modifying a single common property in said selected set of nodes in a single communication.

4. The method of claim 1, further comprising independently modifying separate sets of nodes with separate threads.

5. The method of claim 1, wherein said characteristics of a user interface are selected from a group consisting of: layout, type, attribute, and relationship among individual artifacts.

6. The method of claim 1, wherein said hierarchy is an XML formatted document describing layout of a user interface, types and attributes of user interface artifacts, and relationship among said artifacts.

7. A computer system comprising:
an XML formatted document having multiple nodes described in a hierarchy;
a manager adapted to navigate said hierarchy to select a set of nodes to process with an XPath expression; and
said manager adapted to evaluate said XPath expression and to manipulate said selected set of nodes, wherein said nodes are characteristics of user interface artifacts.

8. The system of claim 7, wherein said selected set of nodes are related by a common property.

9. The system of claim 7, wherein said manager supports modification of a single common property of said selected set of nodes in a single communication.

10. The system of claim 7, further comprising multiple independent threads adapted to independently modify separate sets of nodes.

11. The system of claim 7, wherein said characteristics of a user interface, and said nodes are selected from a group consisting of: layout, type, attribute, and relationship among individual artifacts.

12. The system of claim 7, wherein said hierarchy is an XML formatted document describing layout of a user interface, types and attributes of user interface artifacts, and relationship among said artifacts.

13. An article comprising:
a computer readable medium;
means in the medium for describing nodes of an XML document in a hierarchy;
means in the medium for navigating said hierarchy and selecting at least one set of nodes for processing with an XPath expression; and
means in the medium for evaluating said XPath expression to manipulate said selected set of nodes, wherein said nodes are characteristics of user interface artifacts.

14. The article of claim 13, wherein said selected set of nodes are related by a common property.

15. The article of claim 13, further comprising means in the medium for modifying a single common property of said selected set of nodes in a single communication.

16. The article of claim 13, further comprising means in the medium for independently modifying separate sets of nodes of said document with separate threads.

17. The article of claim 13, wherein said characteristics of said user interface are selected from a group consisting of: layout, type, attribute, and relationship among individual artifacts.

18. The article of claim 13, wherein said hierarchy is an XML formatted document describing layout of a user interface, types and attributes of user interface artifacts, and relationship among said artifacts.
